(19) United States
(12) Patent Application Publication
(10) Pub. No.: US 2020/0110911 A1
(43) Pub. Date: Apr. 9, 2020

(54) PARTICLE SIMULATION DEVICE, PARTICLE SIMULATION METHOD, AND PARTICLE SIMULATION PROGRAM

(71) Applicant: Japan Agency for Marine-Earth Science and Technology, Kanagawa (JP)

(72) Inventor: Daisuke NISHIURA, Yokosuka-shi, Kanagawa (JP)

(73) Assignee: Japan Agency for Marine-Earth Science and Technology, Kanagawa (JP)

(21) Appl. No.: 16/080,875

(22) PCT Filed: Mar. 1, 2017
(86) PCT No.: PCT/JP2017/008168

§ 371 Date: Aug. 29, 2018

(30) Foreign Application Priority Data
Mar. 3, 2016 (JP) 2016-041001

(51) Int. Cl. G06F 30/25

(52) U.S. Cl. CPC G06F 30/25; G06F 2111/10

(57) ABSTRACT

A particle simulation device is a device that simulates behaviors of a particle and a structure. The particle simulation device includes: an initial structure information acquiring unit that acquires information indicating an initial position and a shape of the structure; a virtual area setting unit that sets a plurality of virtual particles in a vicinity of the surface of the structure based on the information and calculates a distance to the structure for each of the plurality of virtual particles; a virtual area specifying unit that specifies one virtual particle within a preset distance from the position of the particle; a particle distance calculating unit that calculates a distance from the particle to the structure based on the distance calculated for the specified virtual particle; and an interaction force calculating unit that calculates an interaction force between the particle and the structure based on the calculated distance.

### TECHNICAL FIELD

The present invention relates to a particle simulation device, a particle simulation method, and a particle simulation program that simulate behaviors of particles and a structure.

### BACKGROUND ART

In the related art, behaviors of particles and a structure having a complicated shape are analyzed by particle-based simulation such as a discrete element method (DEM), smoothed particle hydrodynamics (SPH), and a moving particle semi-implicit (MPS) method. In such simulation, it is necessary to perform contact detection between particles and the structure. Recently, contact detection using a signed distance function has been proposed in consideration of a calculation load, accuracy of simulation, or the like (for example, see Non-Patent Literature 1). A signed distance function is a function which is obtained by dividing a space to be simulated by an orthogonal grid with an arbitrary size and storing a closest distance from a grid point to the surface of a structure at the grid point (for example, see Non-Patent Literature 2). A distance from a particle to a structure is calculated by interpolation using distance function data of a grid at which the particle is located and neighboring grids, and contact detection is performed based on the calculated distance.

### CITATION LIST

### Non Patent Literature

[Non-Patent Literature 1] Y. Shigeto, M. Sakai, Arbitrary-shaped wall boundary modeling based on signed distance functions for granular flow simulations, Chem. Eng. J. 231 (2013) 464-476.
[Non-Patent Literature 2] Y. Wu, J. Man, Z. Xie, A double layer method for constructing signed distance fields from triangle meshes, Graphical Models 76 (2014) 214-223.

### SUMMARY OF INVENTION

### Technical Problem

For movement of a structure with the lapse of time, a distance function is handled, for example, as any one of the following. (1) The distance function is fixed and a coordinate system of a particle is translated and rotated to correspond to translation and rotation of a structure. However, this method cannot be applied when there are a plurality of structures, that is, when there are a plurality of movement axes or rotation axes. (2) A distance function is created again whenever a structure moves. However, this method cannot be appropriately used for actual calculation, because calculation costs for creating a distance function again are high. (3) Advection calculation of a distance function using a differential equation is performed. However, since this method is a grid scheme, numerical diffusion occurs and a distance function becomes dull. Accordingly, it is necessary to perform re-initialization of re-calculating a distance function again at every predetermined time interval. At this time, the distance function which has varied smoothly at previous grid points varies discontinuously and distance oscillation which varies discontinuously occurs. Due to the numerical diffusion or the numerical oscillation, accuracy of simulation is lowered and thus this method is not suitable for actual use in the industrial or scientific fields in view of calculation accuracy. (4) A plurality of pieces of time-series data of a distance function based on movement of a structure are prepared in advance. However, in this method, an amount of data corresponding to the number of grids×the number of time series is necessary and an amount of data which is stored in advance becomes enormous.

The present invention has been made in consideration of the above-mentioned problems and an objective thereof is to provide a particle simulation device, a particle simulation method, and a particle simulation program that can accurately calculate a distance between a particle and a structure with a small calculation load and thus appropriately perform simulation of the particle and the structure.

### Solution to Problem

In order to achieve the above-mentioned objective, a particle simulation device according to an embodiment of the present invention is a particle simulation device that calculates a position and a speed of a particle based on an interaction force between the particle and a structure in a work space and simulates behaviors of the particle and the structure, the particle simulation device including: initial structure information acquiring means that acquires initial structure information indicating an initial position and a shape of the structure; virtual area setting means that sets a plurality of virtual areas in a vicinity of a surface of the structure based on the initial position and the shape of the structure indicated by the initial structure information acquired by the initial structure information acquiring means and calculates a distance to the structure for each of the plurality of set virtual areas; position information acquiring means that acquires position information indicating a position of the particle; virtual area specifying means that specifies the virtual area within a preset distance from the position of the particle indicated by the position information acquired by the position information acquiring means; particle distance calculating means that calculates a distance from the particle to the structure based on the distance calculated by the virtual area setting means for the virtual area specified by the virtual area specifying means; interaction force calculating means that calculates an interaction force between the particle and the structure based on the distance calculated by the particle distance calculating means; and time transition means that calculates a position and a speed of the particle in a next time step based on the interaction force calculated by the interaction force calculating means and moves the virtual area with a positional relationship with the structure maintained.

In the particle simulation device according to the embodiment of the present invention, a distance between a particle and a structure is calculated based on the distances calculated for a plurality of virtual areas set in the vicinity of the surface of the structure. In simulation, the virtual areas move with the positional relationship with the structure maintained. Accordingly, it is not necessary to re-calculate the distances (distance functions) for the virtual areas. Unlike a distance function in the related art, the distances for the virtual areas set in the vicinity of the structure have only to be calculated. Since the virtual areas are set for each structure, the embodiment of the present invention can also be applied when there are a plurality of structures, that is, when there are a plurality of different movement axes or rotation axes. Since the virtual areas associated with distances move, numerical diffusion due to calculation of advection does not occur either. That is, with the particle simulation device according to the embodiment of the present invention, it is possible to accurately calculate a distance between the particle and a structure with a small calculation load and thus to appropriately perform simulation of the particle and the structure.

The virtual area setting means may set a plurality of virtual areas in the vicinity of the surface of the structure in a range based on the preset distance. According to this configuration, it is possible to set the virtual areas as necessary and to efficiently perform simulation of the particle and the structure.

The time transition means may calculate a position and a speed of the structure in the next time step based on the interaction force calculated by the interaction force calculating means. According to this configuration, since an influence of the particle on the structure can also be simulated, it is possible to perform more accurate simulation of the particle and the structure.

Each virtual area may be a particle-shaped area. According to this configuration, it is possible to appropriately and easily handle the virtual areas and to appropriately and easily perform simulation of the particle and the structure.

The present invention can also be described as inventions of a particle simulation method and a particle simulation program as will be described below, in addition to the invention of the particle simulation device. These inventions are substantially the same invention, differing only in category, and achieve the same operations and advantages.

That is, a particle simulation method according to an embodiment of the present invention is a particle simulation method which is an operating method of a particle simulation device that calculates a position and a speed of a particle based on an interaction force between the particle and a structure in a work space and simulates behaviors of the particle and the structure, the particle simulation method including: an initial structure information acquiring step of acquiring initial structure information indicating an initial position and a shape of the structure; a virtual area setting step of setting a plurality of virtual areas in a vicinity of a surface of the structure based on the initial position and the shape of the structure indicated by the initial structure information acquired in the initial structure information acquiring step and calculating a distance to the structure for each of the plurality of set virtual areas; a position information acquiring step of acquiring position information indicating a position of the particle; a virtual area specifying step of specifying the virtual area within a preset distance from the position of the particle indicated by the position information acquired in the position information acquiring step; a particle distance calculating step of calculating a distance from the particle to the structure based on the distance calculated in the virtual area setting step for the virtual area specified in the virtual area specifying step; an interaction force calculating step of calculating an interaction force between the particle and the structure based on the distance calculated in the particle distance calculating step; and a time transition step of calculating a position and a speed of the particle in a next time step based on the interaction force calculated in the interaction force calculating step and moving the virtual area with a positional relationship with the structure maintained.

A particle simulation program according to an embodiment of the present invention is a particle simulation program causing a computer to serve as a particle simulation device that calculates a position and a speed of a particle based on an interaction force between the particle and a structure in a work space and simulates behaviors of the particle and the structure, the particle simulation program causing the computer to serve as: initial structure information acquiring means that acquires initial structure information indicating an initial position and a shape of the structure; virtual area setting means that sets a plurality of virtual areas in a vicinity of a surface of the structure based on the initial position and the shape of the structure indicated by the initial structure information acquired by the initial structure information acquiring means and calculates a distance to the structure for each of the plurality of set virtual areas; position information acquiring means that acquires position information indicating a position of the particle; virtual area specifying means that specifies the virtual area within a preset distance from the position of the particle indicated by the position information acquired by the position information acquiring means; particle distance calculating means that calculates a distance from the particle to the structure based on the distance calculated by the virtual area setting means for the virtual area specified by the virtual area specifying means; interaction force calculating means that calculates an interaction force between the particle and the structure based on the distance calculated by the particle distance calculating means; and time transition means that calculates a position and a speed of the particle in a next time step based on the interaction force calculated by the interaction force calculating means and moves the virtual area with a positional relationship with the structure maintained.

### Advantageous Effects of Invention

In an embodiment of the present invention, it is not necessary to re-calculate the distances (distance functions) for the virtual areas. Unlike a distance function in the related art, the distances for the virtual areas set in the vicinity of the structure have only to be calculated. Since the virtual areas are set for each structure, the embodiment of the present invention can be applied when there are a plurality of structures, that is, when there are a plurality of different movement axes or rotation axes. Since the virtual areas associated with distances move, numerical diffusion due to calculation of advection does not occur either. That is, according to the embodiment of the present invention, it is possible to accurately calculate a distance between the particle and a structure with a small calculation load and thus to appropriately perform simulation of the particle and the structure.

### BRIEF DESCRIPTION OF DRAWINGS

FIG. 1 is a diagram illustrating a functional configuration of a particle simulation device according to an embodiment of the present invention.

FIG. 2 is a diagram schematically illustrating virtual particles with respect to a structure.

FIG. 3 is a diagram illustrating a range and a state in which virtual particles are arranged with respect to a structure.

FIG. 4 is a diagram schematically illustrating virtual particles within a preset distance from a particle to be simulated.

FIG. 5 is a flowchart illustrating a process (a particle simulation method) which is performed by the particle simulation device according to the embodiment of the present invention.

FIG. 6 is a diagram illustrating states (snapshots) while simulation is being performed in the embodiment of the present invention.

FIG. 7 is a diagram illustrating a configuration of a particle simulation program according to an embodiment of the present invention along with a recording medium.

### DESCRIPTION OF EMBODIMENTS

Hereinafter, a particle simulation device, a particle simulation method, and a particle simulation program according to an embodiment of the present invention will be described in detail with reference to the accompanying drawings. In description with reference to the drawings, the same elements will be referred to by the same reference signs and description thereof will not be repeated.

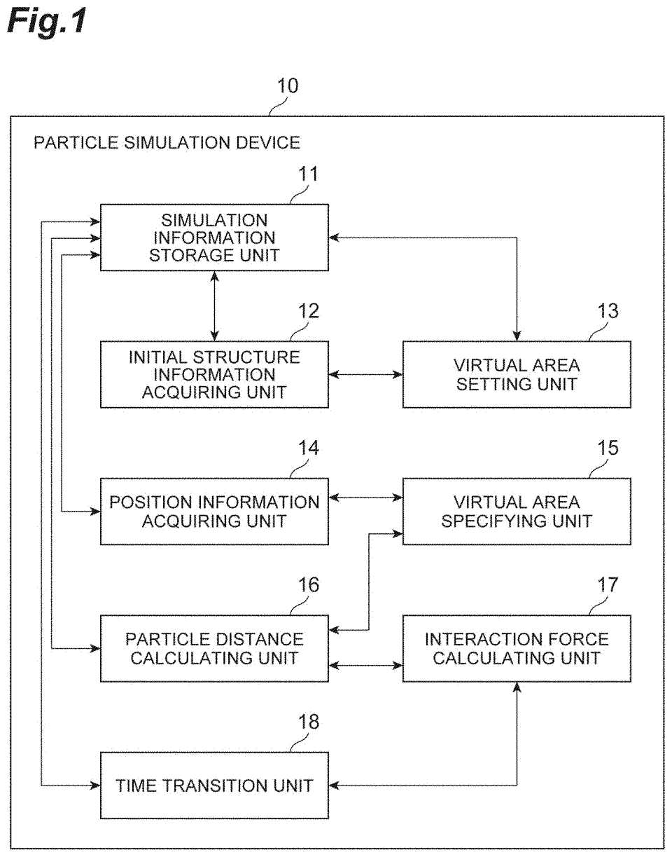

FIG. 1 illustrates a particle simulation device 10 according to this embodiment. The particle simulation device 10 is a device that simulates (analyzes) behaviors of a plurality of spherical particles (with a shape in which a distance from the center to the surface is constant) and a structure in a work space (a calculation area). Specifically, the particle simulation device calculates a force acting on each particle based on positions and speeds of the particles and the structure for each time step which is a time in simulation. The forces acting on each particle and the structure include contact forces which are interaction forces due to contact (collision) which is an interaction between each particle and the structure and between the particles. The interactions between the particles and the structure and between the particles are not limited to contact, but may be arbitrary as long as they affect a position and a speed. The particle simulation device 10 calculates positions and speeds of the particles and the structure in a next time step based on the calculated forces. Particle simulation in this embodiment is performed based on the DEM, but may be performed based on other particle methods such as SPH or MPS. A particle diameter or a rotational speed may not be stored as information depending on the type of the particle method.

Particles which are simulated by the particle simulation device 10 according to this embodiment include arbitrary particles which are subjected to particle simulation in the related art. For example, soil or a powder may be used as a target. Alternatively, a fluid or solid may be used as a target on the assumption that the fluid or the solid includes a plurality of particles. A structure which is simulated by the particle simulation device 10 according to this embodiment includes an arbitrary object. For example, (a part (a mixing impeller) for agitating and mixing powder of) a device that agitates and mixes powder may be simulated. There may be a plurality of structures to be simulated.

Physical problems can be simulated by simulation using the particle simulation device 10 according to this embodiment. For example, simulation associated with agitation and mixing of a powder can be performed. Alternatively, the simulation can also be used for verification of an excavation capacity based on a shape of a drill bit or design of a construction machine or a heavy machine such as a bulldozer. In this way, the simulation using the particle simulation device 10 according to this embodiment can be applied to industrial fields of civil engineering, powders, or the like. The simulation can also be used for simulation of interactions between banks, buildings, or landforms and a tsunami or soil, or a natural phenomenon such as a landslide or avalanche. In this way, the simulation using the particle simulation device 10 according to this embodiment can be applied to the field of disaster preparedness.

The particle simulation device 10 is constituted as a computer including hardware such as a central processing unit (CPU), a graphics processing unit (GPU), a memory, a hard disk, and a display. By causing such elements to operate in accordance with a program or the like, functions of the particle simulation device 10 which will be described later are implemented. The particle simulation device 10 operates particularly effectively by using a device which can perform parallel operations. The particle simulation device 10 does not have to include the GPU as a calculation device, and may have a configuration including only the CPU.

As illustrated in FIG. 1, the particle simulation device 10 includes a simulation information storage unit 11, an initial structure information acquiring unit 12, a virtual area setting unit 13, a position information acquiring unit 14, a virtual area specifying unit 15, a particle distance calculating unit 16, an interaction force calculating unit 17, and a time transition unit 18.

A work space which is an area in which particles moves in this embodiment is, for example, a three-dimensional space and is split (divided) into cubic cells (meshes) of which one side length is preset. A cell may have a shape other than a cubic shape, for example, a rectangular parallelepiped shape. The particle simulation device 10 divides a work space into cells in advance before performing a simulation process and ascertains how the work space is divided into cells. For example, the length of one side is set in advance depending on particle diameters of a plurality of particles to be simulated. A cell number for identifying a cell is given to each cell in the work space. For example, the cell numbers are sequentially assigned depending on positions of cells in the work space.

The simulation information storage unit 11 is means that stores information which is used for simulation. Specifically, the simulation information storage unit 11 stores particle information of a plurality of particles in the work space. Particle information includes information indicating coordinates of particles, speeds of particles, and radii of particles. Coordinates of a particle are three-dimensional coordinates indicating a position of a particle in the work space. Speeds of particles include a translational speed and a rotational speed. Regarding the coordinates of particles and the speeds of particles, information at the time of starting simulation (initial information) is input to the simulation information storage unit 11 in advance by a user of the particle simulation device 10 or the like, and information during simulation is updated by the time transition unit 18 which will be described later. The radii of particles are input to the simulation information storage unit 11 in advance by a user of the particle simulation device 10 or the like.

The simulation information storage unit 11 stores structure information for each structure in the work space. The structure information includes information indicating coordinates of the structure, a speed of the structure, and a shape of the structure. Coordinates of the structure are three-dimensional coordinates indicating a position of the structure (for example, a position of a specific part of the structure) in the work space. The speed of the structure includes a translational speed and a rotational speed. Regarding the coordinates of the structure and the speed of the structure, similarly to the coordinates of particles and the speeds of particles, information at the time of starting simulation (initial information) is input to the simulation information storage unit 11 in advance by a user of the particle simulation device 10 or the like, and information during simulation is updated by the time transition unit 18 which will be described later. For example, information indicating the shape of the structure is computer-aided design (CAD) data in which the shape of the structure is expressed in polygons. The information indicating the shape of the structure is input to the simulation information storage unit 11 in advance by a user of the particle simulation device 10 or the like. The structure information may include information indicating how the structure moves (for example, a movement axis or a rotation axis). The information is also input to the simulation information storage unit 11 in advance by a user of the particle simulation device 10 or the like.

The simulation information storage unit 11 stores information of virtual particles as will be described later. The simulation information storage unit 11 may input and store information which is used for simulation in advance in addition to the particle information and the structure information. Examples of such information include a friction coefficient, an elastic modulus, a viscous damping coefficient, and a restitution coefficient.

The initial structure information acquiring unit 12 is initial structure information acquiring means that acquires initial structure information indicating the initial position and the shape of the structure. For example, the initial structure information acquiring unit 12 acquires initial information related to a structure and information indicating a shape of a structure which are stored in the simulation information storage unit 11 as initial structure information. The initial structure information acquiring unit 12 outputs the acquired initial structure information to the virtual area setting unit 13.

The virtual area setting unit 13 is virtual area setting means that sets a plurality of virtual areas in a vicinity of the surface of the structure based on the initial position and the shape of the structure indicated by the initial structure information acquired by the initial structure information acquiring unit 12 and calculates a distance to the structure (a closest distance) for each of the plurality of set virtual areas. As will be described later, a virtual area is an area which is used to calculate a distance to the structure from a particle to be simulated. In this embodiment, a virtual area is a particle-shaped area having a spherical shape (a shape in which a distance from the center to the surface is constant) and is referred to as a virtual particle. The diameters of a plurality of virtual particles are the same and are set in advance. A virtual particle may be set to be larger than a particle to be simulated in consideration of a calculation load or the like.

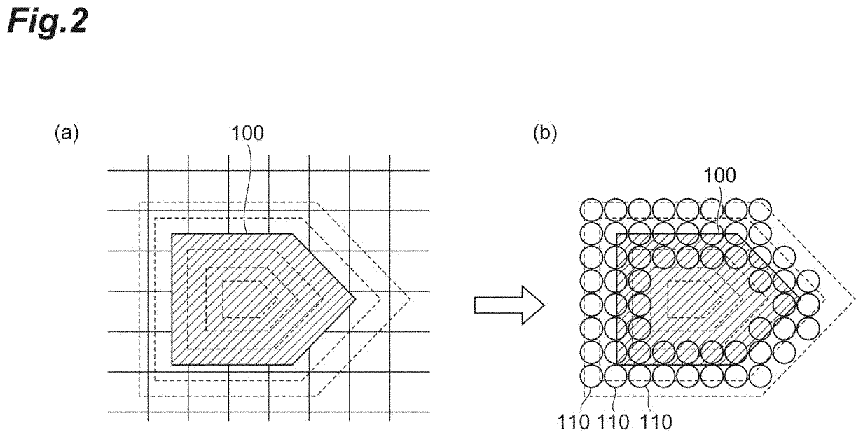

As described above, in the related art, a distance to a structure from a particle to be simulated is calculated using a signed distance function as described in Non-Patent Literature 1. For example, a signed distance function stores distances to the structure at grid points by which a work space is divided into cells (orthogonal grids). An isopleth diagram in which positions with the same distance from a structure 100 which are generated based on distance functional values of grid points are connected by a line is illustrated in FIG. 2(a). In this embodiment, as illustrated in FIG. 2(b), a plurality of virtual particles 110 are set in the vicinity of the surface of the structure 100 (a boundary between the structure 100 and the other part).

Specifically, the virtual area setting unit 13 first calculates a signed distance function for the structure 100 of which the initial position and the shape are indicated by the initial structure information. This calculation can be performed using a conventional method as described in Non-Patent Literature 2. The virtual area setting unit 13 detects a position near the structure 100 in the work space based on the calculated signed distance function. The position near the structure includes areas on the outside, the surface, and the inside of the structure as illustrated in FIG. 2(b). The virtual area setting unit 13 sets a plurality of virtual particles 110 in the areas in the vicinity to come into contact with each other. For example, when the work space is a three-dimensional space, the virtual area setting unit 13 sets grid points of a simple cubic lattice or a face-centered cubit lattice in the area and sets (arranges) the virtual particles 110 at the grid points. Since the distance to the structure 100 has only to be known, the signed distance function does not have to be used for setting the virtual particles and the setting of the virtual particles may be performed using an arbitrary method.

A part on the surface of the structure 100 in which the virtual particles 110 are set is a part with a likelihood that a particle to be simulated will come in contact with (interact with) the part. When there is a likelihood that particles will come in contact with the entire surface of the structure 100, the virtual particles 110 are set in the vicinity of the entire surface of the structure 100 as illustrated in FIG. 2(b). When a part without a likelihood that the part will come in contact with the structure is known in advance, the virtual particles 110 may not be set in the vicinity of the part.

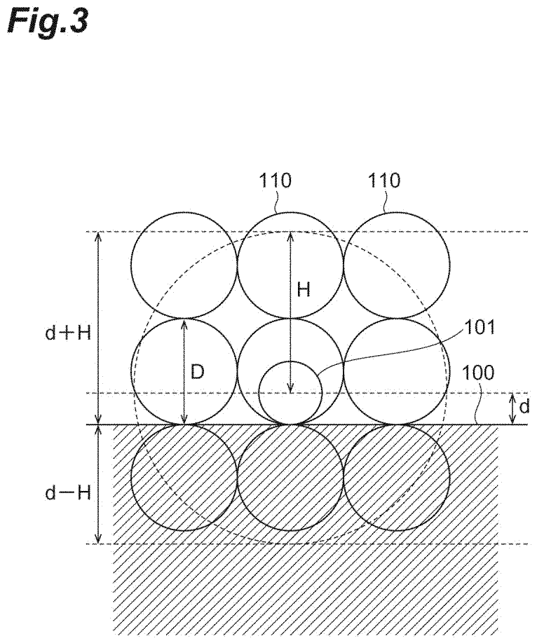

The virtual area setting unit 13 sets a range of a predetermined distance (a predetermined thickness) to be the vicinity of the structure in a normal direction of the surface of the structure 100. For example, as illustrated in FIG. 3, with a position separated a distance d outward from the surface of the structure 100 as a center of the distance, areas within a distance H to the outside and the inside from the position (in the vertical direction in FIG. 3) are set as the areas in the vicinity of the structure 100. The distance d is a distance between the surface of the structure 100 and the center of a particle 101 to be simulated at which the particle 101 starts interaction with the structure 100. When the sizes of the particles 101 to be simulated are not constant or when the distances at which interaction is started are not constant for the particles 101, for example, a minimum value thereof may be used for d-H in FIG. 3 and a maximum value thereof may be used for d+H.

When the interaction is contact, the distance d is a radius of a particle 101. The distance H is a distance for specifying virtual particles 110 which are used to calculate a distance from the particle 101 to the structure 100 (details of which will be described later). The distance H is set in advance. As described above, the virtual area setting unit 13 may set a plurality of virtual particles 110 in the vicinity of the surface of the structure 100 within a range based on the distance H. When the distance d is larger than the distance H, the virtual particles 110 may not be set on the surface and the inside of the structure 100. The area in which the virtual particles 110 are set (a distance or a thickness in the normal direction) does not have to be set (calculated) as described above, and may be set in advance.

As will be described later, a positional relationship between the structure 100 and the set virtual particles 110 is fixed during simulation.

The virtual area setting unit 13 calculates a distance from each set virtual particle 110 to the structure 100 (the surface on which it is arranged), for example, a distance from the center position of the virtual particle 110 to the surface of the structure 100, for each virtual particle 110. An arbitrary method such as an interpolation method using a conventional signed distance function can be used for this calculation. The distance from each virtual particle 110 to the structure 100 may be calculated at the same time as arranging the virtual particle 110. The set virtual particles 110 may be uniquely specified by assigning unique numbers to the virtual particles 110 or the like. The virtual area setting unit 13 stores information indicating the positions and the distances of the set virtual particles 110 in the simulation information storage unit 11.

The virtual area setting unit 13 may calculate a normal vector of the surface of the structure 100 at the time of calculating the distances of the virtual particles 110 and associate the calculated normal vector with the distance. Information of the normal vector can be used for an interpolation process which will be described later. Mechanical properties such as Young's modulus may be associated with the virtual particles 110 and may be used for processes which will be described later.

The processes of the initial structure information acquiring unit 12 and the virtual area setting unit 13 are performed before calculation for each time step in the simulation is performed. The following functional units are elements for calculation for each time step in the simulation.

The position information acquiring unit 14 is position information acquiring means that acquires position information indicating positions of particles 101 to be simulated. Specifically, the position information acquiring unit 14 acquires particle information of the particles 101 in the current time step stored in the simulation information storage unit 11 as the position information of the particles 101. The position information acquiring unit 14 inputs the acquired particle information of the particles 101 to the virtual area specifying unit 15.

The position information acquiring unit 14 also acquires position information indicating the positions of the virtual particles 110. The position information acquiring unit 14 acquires information indicating the positions of the particles 101 in the current time step stored in the simulation information storage unit 11. The position information acquiring unit 14 outputs the acquired position information of the virtual particles 110 to the virtual area specifying unit 15.

The virtual area specifying unit 15 is virtual area specifying means that specifies virtual particles 110 within a preset distance H from the position of a particle 110 indicated by the position information acquired by the position information acquiring unit 14. Here, the specified virtual particles 110 are used to calculate the distance from the particle 101 to the structure 100 by interpolation. That is, the distance H is a distance indicating a range (an interpolation range) in which interpolation is performed and is set in advance to a value with which the distance from the particle 110 to the structure 100 can be appropriately calculated by interpolation. Specifically, the distance H preferably satisfies H>D√n when the virtual particles 110 are set in a simple cubic lattice shape, and preferably satisfies H>D when the virtual particles 110 are set in a face-centered cubit lattice shape. In the above-mentioned relational expressions, D denotes the diameter of a virtual particle 110 as illustrated in FIG. 3, and n denotes the number of dimensions of the work space.

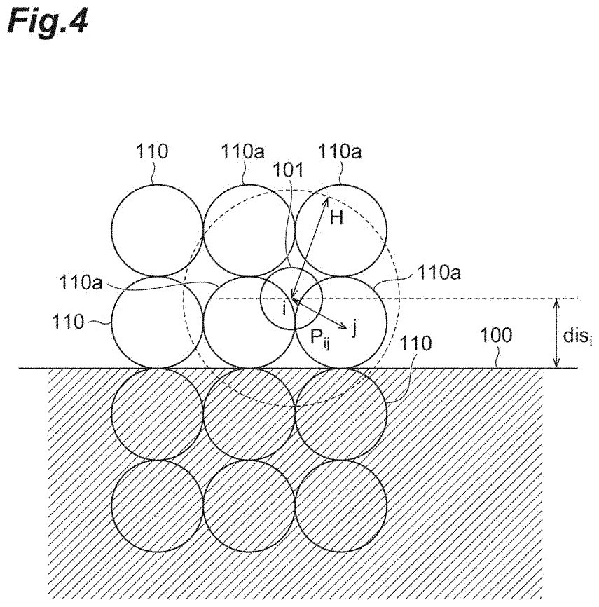

As illustrated in FIG. 4, the virtual area specifying unit 15 calculates a distance Pᵢⱼ between the position of a particle 101 (particle i) (the center position of the particle 101) indicated by the information input from the position information acquiring unit 14 and the position of each virtual particle 110 (particle j) (the center position of the virtual particle 110) for each particle 101. The virtual area specifying unit 15 determines whether the calculated distance Pᵢⱼ is less than the distance H. The virtual area specifying unit 15 specifies virtual particles 110 of which the distance from the particle 101 is less than the distance H for each particle 101 based on the determination result. In the example illustrated in FIG. 4, four virtual particles 110a are specified. The virtual area specifying unit 15 outputs information indicating the specified virtual particles 110 to the particle distance calculating unit 16 for each particle 101.

Specification of the virtual particles 110 within the distance H may be efficiently performed using a method of contact detection between particles in conventional particle simulation (detection of whether a distance between particles is less than a threshold value). For example, as described in Japanese Unexamined Patent Publication No. 2015-115567 (Patent Literature 1) and Japanese Unexamined Patent Publication No. 2010-238030 (Patent Literature 2), a method of setting a pair of a particle 101 and a virtual particle 110 based on a cell in which the particle 101 and the virtual particle 110 are located and determining the distance using the pair may be employed.

The particle distance calculating unit 16 is particle distance calculating means that calculates a distance from a particle 101 to the structure 100 (a closest distance) based on the distance calculated by the virtual area setting unit 13 for the virtual particles 110 specified by the virtual area specifying unit 15. The particle distance calculating unit 16 acquires information indicating the distances from the specified virtual particles 110 to the structure 100 stored in the simulation information storage unit 11 for each particle 101. The particle distance calculating unit 16 calculates a distance from the particle 101 to the structure 100 (a distance disᵢ from the center position of the particle 101 (particle i) to the surface of the structure 100 which is illustrated in FIG. 4) based on the distances indicated by the acquired information. This calculation may be performed, for example, by conventional interpolation described in Non-Patent Literature 1 or may be performed using other arbitrary methods. For example, Kernel approximation which is used in the SPH or the like can also be used.

When there is no specified virtual particle 110 or when the number of specified virtual particles 110 is not sufficient to perform the interpolation (for example, equal to or less than a preset threshold value), it is determined that the distance to the structure 100 is not at least a distance at which an interaction occurs for the corresponding particle 101, and the distance to the structure 100 is not calculated. In this case, the processes using the distance are not also performed. The particle distance calculating unit 16 outputs information indicating the distance to the structure 100 calculated for each particle 101 to the interaction force calculating unit 17.

The particle distance calculating unit 16 generally calculates a normal vector from the particle 101 to the surface of the structure 100 at the time of calculating the distance. By using the normal vector, an interaction force calculated by the interaction force calculating unit 17 can be expressed in a vector. The direction of the vector represents a direction in which the interaction force acts. The normal vector can be calculated by calculating a spatial gradient for the distance from the virtual particles 110 specified for each particle 101 to the structure 100 (distance function data). Calculation of the normal vector based on the spatial gradient may be performed using a convention method, for example, described in Non-Patent Literature 1. Alternatively, when a normal vector is calculated in advance for the virtual particles 110, the normal vector may be calculated by interpolation of the information. The normal vector may be calculated using other arbitrary methods. For example, a gradient calculation method based on Kernel approximation which is used in the SPH or the like can be used. The particle distance calculating unit 16 outputs information indicating the calculated normal vector along with information indicating the distance to the interaction force calculating unit 17.

The interaction force calculating unit 17 is interaction force calculating means that calculates an interaction force between a particle 101 and the structure 100 based on the distance calculated by the particle distance calculating unit 16. The interaction force calculating unit 17 determines whether an interaction between the particle 101 and the structure 100 can occur (interaction determination) by determining whether the distance from the particle 101 to the structure 100 is less than a preset threshold value. When it is determined that the distance is less than the threshold value, the interaction force calculating unit 17 determines that an interaction between the particle 101 and the structure 100 occurs. When it is determined that the distance is not less than the threshold value, the interaction force calculating unit 17 determines that an interaction between the particle 101 and the structure 100 does not occur.

For example, when the interaction is contact, the interaction force calculating unit 17 determines whether the distance is less than the radius d of the particle 101 which is a threshold value, and determines that the particle 101 and the structure 100 are in contact with each other and a contact force is generated therebetween when it is determined that the distance is less than the threshold value. Calculation of an interaction force can be performed using the same method as the conventional particle simulation or other arbitrary methods. In general, the interaction force calculating unit 17 calculates an interaction force as a vector based on the normal vector from the particle 101 to the surface of the structure 100 which is calculated by the particle distance calculating unit 16.

The interaction force calculating unit 17 may calculate an interaction force between particles 101 and an interaction force between structures 100 in addition to the interaction force between the particle 101 and the structure 100. Calculation of the interaction force between particles 101 can be performed using the same method as the conventional particle simulation described in Patent Literatures 1 and 2 or other arbitrary methods. Calculation of the interaction force between structures 100 can also be performed using the same method as the conventional simulation or other arbitrary methods. In calculation of an interaction force, parameters required for calculation of an interaction force stored in the simulation information storage unit 11 may be acquired and may be used for calculation of an interaction force.

The interaction force calculating unit 17 calculates the total interaction force for each particle 101 and each structure 100 from the interaction forces between the individual particles 101 and the structures 100, the interaction forces between the particles 101, and the interaction forces between the structures 100 which are calculated as described above. The interaction force calculating unit 17 outputs information indicating the calculated total interaction force for the particles 101 and the structures 100 to the time transition unit 18.

The time transition unit 18 is time transition means that calculates positions and speeds of the particles 101 and the structures 100 in a next time step based on the interaction force calculated by the interaction force calculating unit 17 and moves the virtual particles 110 with the positional relationship with the structure 100 maintained. Specifically, the time transition unit 18 acquires the particle information and the structure information stored in the simulation information storage unit 11 for each particle 101 and each structure 100 and calculates coordinates and speeds in the next time step from the coordinates and the speeds in the current time step indicated by the particle information and the structure information and the total interaction force. This calculation can be performed, for example, using the same method as the conventional simulation or other arbitrary methods. The time transition unit 18 updates the particle information and the structure information stored in the simulation information storage unit 11 with the calculated positions and speeds of the particles 101 and the structures 100 in the next time step for each particle 101 and each structure 100.

When the position of the structure 100 in the next time step is calculated, the time transition unit 18 moves the virtual particles 110 set for the structure 100 with the positional relationship with the structure 100 maintained (in the same way as movement of the structure 100). The time transition unit 18 updates information indicating the virtual particles 110 stored in the simulation information storage unit 11 with the information indicating the positions of the moved virtual particles 110 (stores the information as information indicating the positions of the virtual particles 110 in the next time step in the simulation information storage unit 11).

Regarding the structure 100, calculation of the position and the speed based on the interaction force may not be performed. For example, when an influence of the particle 101 on the structure 100 is very small and an interaction between the structures 100 does not occur, the calculation may not be performed. In this case, for example, information indicating how the structure 100 moves may be stored in the simulation information storage unit 11 in advance and the time transition unit 18 may calculate movement of the structure 100 (the position and the speed in the next time step) on the basis thereof. The time transition unit 18 moves the virtual particles 110 with the movement of the structure 100 (along a predetermined locus of the surface of the structure 100).

When update is performed on all the particles 101, all the structures 100, and all the virtual particles 110 by the time transition unit 18, a process in the next time step is performed.

In the particle simulation device 10, it is determined whether ending conditions of simulation have been satisfied whenever calculation in one time step has been completed. For example, when a predetermined number of times (time steps) of calculation has ended, it is determined that ending conditions have been satisfied. When it is determined that ending conditions have been satisfied, the particle simulation device 10 ends the simulation. In this case, for example, output of calculation results to a display device or another device is performed. When it is determined that ending conditions have not been satisfied, calculation in the next time step is repeatedly performed. The above is a configuration of the particle simulation device 10.

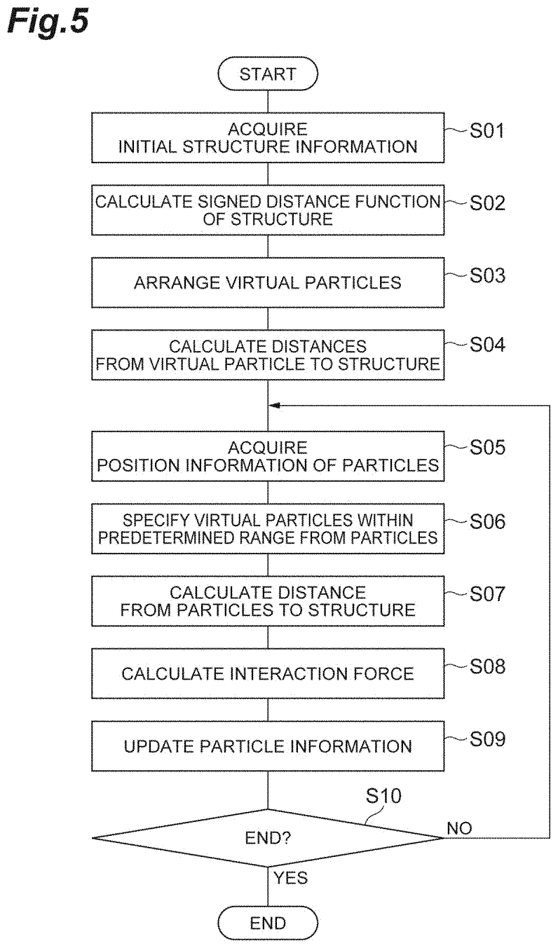

A process (a particle simulation method) which is performed by the particle simulation device 10 according to this embodiment and which is an operating method of the particle simulation device 10 will be described below with reference to the flowchart illustrated in FIG. 5. The present processing is started, for example, by the user of the particle simulation device 10 performing the operation of starting simulation for the particle simulation device 10.

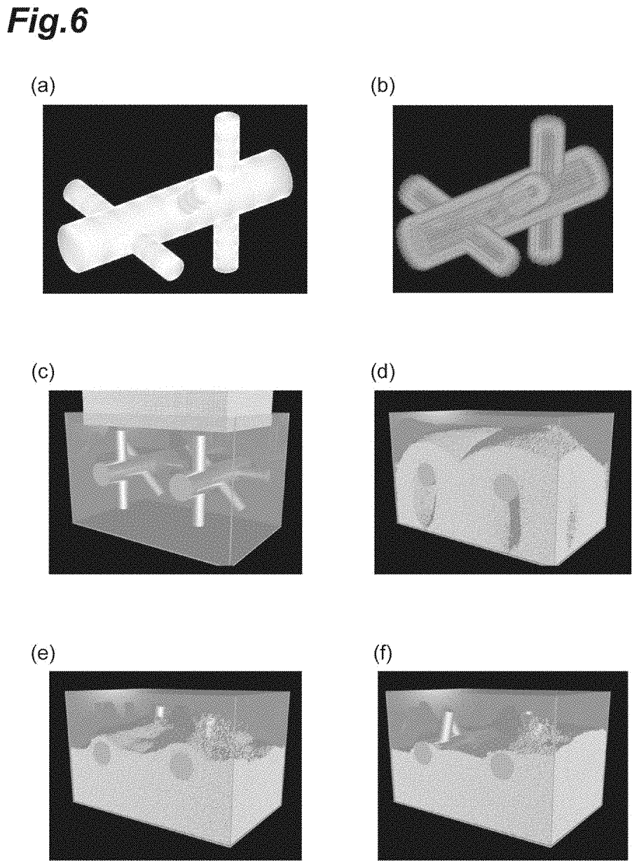

In the particle simulation device 10, the initial structure information acquiring unit 12 acquires initial structure information indicating an initial position and a shape of a structure 100 which is stored in the simulation information storage unit 11 (S01, an initial structure information acquiring step). An example of the shape of the structure 100 is illustrated in FIG. 6(a). The acquired initial structure information is output from the initial structure information acquiring unit 12 to the virtual area setting unit 13.

Subsequently, the virtual area setting unit 13 calculates a signed distance function of the structure 100 related to the initial structure information (S02, a virtual area setting step). Subsequently, the virtual area setting unit 13 arranges (sets) a plurality of virtual particles 110 in the vicinity of the surface of the structure 100 using the signed distance function (S03, a virtual are setting step). An example of the virtual particles 110 set in the vicinity of the surface of the structure 100 is illustrated in FIG. 6(b). Subsequently, the virtual area setting unit 13 calculates a distance from the virtual particle 110 to the structure 100 for each virtual particle 110 (S04, a virtual area setting step). Information indicating the positions of the distances of the virtual particles 110 is stored in the simulation information storage unit 11. The above is the process which is performed before calculation of each time step in the simulation.

Subsequently, the position information acquiring unit 14 acquires position information indicating the positions of the particles 101 to be simulated and the virtual particles 110 which is stored in the simulation information storage unit 11 (S05, a position information acquiring step). The acquired position information is output from the position information acquiring unit 14 to the virtual area specifying unit 15.

Subsequently, the virtual area specifying unit 15 specifies virtual particles 110 within the distance H from the position of a particle 101 indicated by the position information (S06, a virtual area specifying step). Information indicating the specified virtual particles 110 for each particle 101 is output from the virtual area specifying unit 15 to the particle distance calculating unit 16.

Subsequently, the particle distance calculating unit 16 calculates a distance from a particle 101 to the structure 100 based on the distances from the specified virtual particles 110 to the structure 100 for each particle 101 (S07, a particle distance calculating step). This calculation is performed, for example, by interpolation as described above. Information indicating the distance to the structure 100 calculated for each particle 101 is output from the particle distance calculating unit 16 to the interaction force calculating unit 17.

Subsequently, the interaction force calculating unit 17 calculates an interaction force between the particle 101 and the structure 100 based on the distance to the structure 100 calculated for each particle 101 (S08, an interaction force calculating step). At this time, interaction forces between the particles 101 and interaction forces between the structures 100 may be calculated. Subsequently, the interaction force calculating unit 17 calculates the total interaction force for each particle 101 and each structure 100 from the calculated interaction forces. Information indicating the calculated total interaction force for each particle 101 and each structure 100 from the interaction force calculating unit 17 to the time transition unit 18.

Subsequently, the time transition unit 18 calculates positions and speeds of the particles 101 and the structures 100 in the next time step based on the calculated interaction forces and moves the virtual particles 110 with the positional relationship with the structure 100 maintained (S09, a time transition step). The particle information and the structure information stored in the simulation information storage unit 11 and the information indicating the positions of the virtual particles 110 are updated with information in the next time step based on the above-mentioned calculations.

Subsequently, the particle simulation device 10 determines whether ending conditions of the simulation have been satisfied (S10). When it is determined that the ending conditions have been satisfied (YES in S10), the process (simulation) ends. When it is determined that the ending conditions have not been satisfied (NO in S10), the time step advances by one and the above-mentioned processes (S05 to S10) in the next time step are performed.

Examples of states in the time steps are illustrated in FIGS. 6(c) to 6(f). With the progress from FIG. 6(c) to FIG. 6(f), the time step advances. In this simulation, two rotating structures (mixing impellers) for agitating powder in a container are provided, and powder falls into the container from the upper side and is agitated by the structures. Different agitation speeds may be given to the structures. The above is the process which is performed by the particle simulation device 10 according to this embodiment.

As described above, according to this embodiment, a distance between a particles 101 and a structure 100 is calculated based on distances calculated for a plurality of virtual particles 110 set in the vicinity of the surface of the structure 100. In the simulation, the virtual particles 110 are moved with the positional relationship with the structure 100 maintained. Accordingly, it is necessary to re-calculate the distances for the virtual particles 110 (distance functions).

Unlike conventional distance functions at grid points in the entire area of a work space, the distance has only to be calculated for only the virtual particles 110 set in the vicinity of the structure 100. The individual virtual particles 110 are set for each structure 100 and can move independently with movement of each structure 100. That is, when there are a plurality of structures 100, that is, when there are a plurality of different movement axes or rotation axes, this embodiment can be applied.

Since the virtual particles 110 associated with distances move, numerical diffusion due to calculation of advection does not occur and a process of initializing a distance function is not required. Since only the virtual particles 110 are moved, the calculation is much simpler and the calculation load is much smaller than the calculation of advection. That is, according to this embodiment, it is possible to accurately calculate distances between particles 101 and a structure 100 with a small calculation load and thus to appropriately perform simulation of the particles 101 and the structure 100.

As described above, since the distances for only the virtual particles 110 set in the vicinity of the structure 100 are calculated and stored, it is possible to greatly reduce an amount of data (an amount of memory used) to be stored in comparison with the conventional distance function.

An example of an amount of memory used will be described below. An example in which the size of a work space is 160 D×200 D×100 D, an interpolation range H is 3.5 d, the diameter of a virtual particle 110 (a grid size) is D, and an interaction distance d is 0.5 D will be described. In the method according to this embodiment, the number of particles required for distance calculation is 85,336, and the total amount of memory used is 2,730,752 (Bytes) (85,336×4×8: four parameters (x, y, and z coordinates and a distance function value) of 8 bytes are required for one particle). In the conventional method (a case in which a coordinate system of a particle is moved), the number of grids required for distance calculation is 3,200,000 and the total amount of memory used is 102,400,000 (Bytes) (3,200,000×4×8: four parameters (x, y, and z coordinates and a distance function value) of 8 bytes are required for one grid). When calculation of advection of a distance function is performed and, for example, a constrained interpolation profile (CIP) scheme is used, the amount of memory used is 102,400,000+3,200,000×7×8=281,600,000 (Bytes) (seven parameters of 8 bytes are required for one grid). When time-series data of a distance function is used, the amount of memory used is 102,400,000+3,200,000×8=128,000,000 (Bytes) (distance function data of two times are required for time interpolation, a distance function value for one grid is 8 bytes, and total 3,200,000×8 Bytes is additionally required).

As in the above-mentioned example, in this embodiment, it is possible to reduce the amount of memory used to about 1/40 to 1/100 of the conventional amount of memory.

As in this embodiment, the range in which the virtual particles 110 are set (arranged) may be set to be based on a range (an interpolation range) in which the virtual particles 110 used to calculate a distance from a particle 101 to the structure 100 are specified. According to this configuration, it is possible to set the number of virtual particles 110 as necessary and to more efficiently perform simulation of the particles 101 and the structure 100.

As in this embodiment, the structure 100 may be affected by interaction forces from the particles 101. According to this configuration, since an influence of the particles 101 on the structure 100 can be simulated, it is possible to perform more accurate simulation of the particles 101 and the structure 100.

As in this embodiment, the virtual areas may be defined as the virtual particles 110. According to this configuration, it is possible to appropriately and easily handle the virtual areas. For example, as described above, it is possible to easily apply the conventional particle-based simulation method and to increase the speed of the method according to this embodiment. That is, it is possible to appropriately and easily perform simulation of the particles 101 and the structure 100. The virtual area does not have to be set to a particle-shaped area, but may be set to an area having an arbitrary shape.

In the above-mentioned embodiment, the work space is set to a three-dimensional space, but may be a space other than the three-dimensional space, for example, a two-dimensional space.

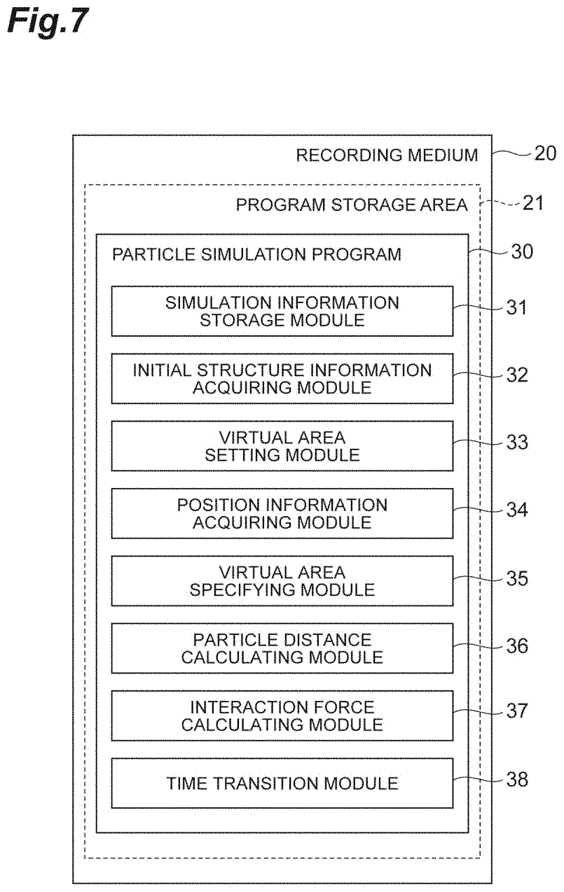

A particle simulation program causing a computer to execute the above-mentioned sequence of processes in the particle simulation device 10 will be described below. As illustrated in FIG. 7, a particle simulation program 30 is stored in a program storage area 21 which is formed in a recording medium 20 which is inserted into the computer and is accessed or which is included in the computer.

The particle simulation program 30 includes a simulation information storage module 31, an initial structure information acquiring module 32, a virtual area setting module 33, a position information acquiring module 34, a virtual area specifying module 35, a particle distance calculating module 36, an interaction force calculating module 37, and a time transition module 38. The functions which are implemented by executing the simulation information storage module 31, the initial structure information acquiring module 32, the virtual area setting module 33, the position information acquiring module 34, the virtual area specifying module 35, the particle distance calculating module 36, the interaction force calculating module 37, and the time transition module 38 are the same as the simulation information storage unit 11, the initial structure information acquiring unit 12, the virtual area setting unit 13, the position information acquiring unit 14, the virtual area specifying unit 15, the particle distance calculating unit 16, the interaction force calculating unit 17, and the time transition unit 18 of the particle simulation device 10.

A part or all of the particle simulation program 30 may be transmitted via a transmission medium such as a communication line and be received and recorded (which includes being installed) by another device. The modules of the particle simulation program 30 may not be installed in one computer, but be installed in some of a plurality of computers. In this case, the above-mentioned sequence of processes of the particle simulation program 30 is performed by a computer system including the plurality of computers.

### REFERENCE SIGNS LIST

10 Particle simulation device
11 Simulation information storage unit
12 Initial structure information acquiring unit
13 Virtual area setting unit
14 Position information acquiring unit
15 Virtual area specifying unit
16 Particle distance calculating unit
17 Interaction force calculating unit
18 Time transition unit
20 Recording medium
21 Program storage area
30 Particle simulation program
31 Simulation information storage module
32 Initial structure information acquiring module
33 Virtual area setting module
34 Position information acquiring module
35 Virtual area specifying module
36 Particle distance calculating module
37 Interaction force calculating module
38 Time transition module

1. A particle simulation device that calculates a position and a speed of a particle based on an interaction force between the particle and a structure in a work space and simulates behaviors of the particle and the structure, the particle simulation device comprising circuitry configured to:
acquire initial structure information indicating an initial position and a shape of the structure;
set a plurality of virtual areas in a vicinity of a surface of the structure based on the initial position and the shape of the structure indicated by the initial structure information and calculates a distance to the structure for each of the plurality of set virtual areas;
acquire position information indicating a position of the particle;
specify the virtual area within a preset distance from the position of the particle indicated by the position information;
calculate a distance from the particle to the structure based on the distance for the virtual area;
calculate an interaction force between the particle and the structure based on the distance; and
calculate a position and a speed of the particle in a next time step based on the interaction force and moves the virtual area with a positional relationship with the structure maintained.

2. The particle simulation device according to claim 1, wherein the circuitry sets a plurality of virtual areas in the vicinity of the surface of the structure in a range based on the preset distance.

3. The particle simulation device according to claim 1, wherein the circuitry calculates a position and a speed of the structure in the next time step based on the interaction force.

4. The particle simulation device according to claim 1, wherein each virtual area is a particle-shaped area.

5. A particle simulation method which is an operating method of a particle simulation device that calculates a position and a speed of a particle based on an interaction force between the particle and a structure in a work space and simulates behaviors of the particle and the structure, the particle simulation method comprising:
an initial structure information acquiring step of acquiring initial structure information indicating an initial position and a shape of the structure;
a virtual area setting step of setting a plurality of virtual areas in a vicinity of a surface of the structure based on the initial position and the shape of the structure indicated by the initial structure information acquired in the initial structure information acquiring step and calculating a distance to the structure for each of the plurality of set virtual areas;
a position information acquiring step of acquiring position information indicating a position of the particle;
a virtual area specifying step of specifying the virtual area within a preset distance from the position of the particle indicated by the position information acquired in the position information acquiring step;
a particle distance calculating step of calculating a distance from the particle to the structure based on the distance calculated in the virtual area setting step for the virtual area specified in the virtual area specifying step;
an interaction force calculating step of calculating an interaction force between the particle and the structure based on the distance calculated in the particle distance calculating step; and
a time transition step of calculating a position and a speed of the particle in a next time step based on the interaction force calculated in the interaction force calculating step and moving the virtual area with a positional relationship with the structure maintained.

6. A particle simulation program causing a computer to serve as a particle simulation device that calculates a position and a speed of a particle based on an interaction force between the particle and a structure in a work space and simulates behaviors of the particle and the structure, the particle simulation program causing the computer to execute:
initial structure information acquiring function of acquiring initial structure information indicating an initial position and a shape of the structure;
virtual area setting function of setting a plurality of virtual areas in a vicinity of a surface of the structure based on the initial position and the shape of the structure indicated by the initial structure information and calculates a distance to the structure for each of the plurality of set virtual areas;
position information acquiring function of acquiring position information indicating a position of the particle;
virtual area specifying function of specifying the virtual area within a preset distance from the position of the particle indicated by the position information;
particle distance calculating function of calculating a distance from the particle to the structure based on the distance for the virtual area;
interaction force calculating function of calculating an interaction force between the particle and the structure based on the distance; and
time transition function of calculating a position and a speed of the particle in a next time step based on the interaction force and moves the virtual area with a positional relationship with the structure maintained.
